(19) United States
(12) Patent Application Publication
(10) Pub. No.: US 2024/0273030 A1
(43) Pub. Date: Aug. 15, 2024

(54) PROCESSOR SYSTEM INCLUDING TABLE-BASED MEMORY PROTECTION FOR IMPROVED PERFORMANCE FOR SHARED MEMORY

(71) Applicant: QUALCOMM Incorporated, San Diego, CA (US)

(72) Inventors: James BALL, San Diego, CA (US); Bohuslav RYCHLIK, San Diego, CA (US)

(21) Appl. No.: 18/399,525

(22) Filed: Dec. 28, 2023

Related U.S. Application Data
(60) Provisional application No. 63/484,444, filed on Feb. 10, 2023.

(51) Int. Cl. G06F 12/0877; G06F 12/0817

(52) U.S. Cl. CPC G06F 12/0877; G06F 12/0822

(57) ABSTRACT

A processor system, comprising: a first memory comprising a memory protection table including memory access permission information associated with a set of one or more worlds; and a processor comprising: an execution core configured to run a first world; and a table-based memory protection (TMP) configured to: receive a first request to access memory content at a first target address from the first world; access the memory access permission information from the memory protection table based on the first target address; and determine whether the first world is allowed to access the memory content at the first target address based on the accessed memory access permission information.

### CROSS-REFERENCE TO RELATED APPLICATION

This application claims the benefit of the filing date of U.S. Provisional Application, 63/484,444, filed on Feb. 10, 2023, which is incorporated herein by reference.

### FIELD

Aspects of the present disclosure relate generally to processor systems, and in particular, to a processor system including table-based memory protection (TMP) for improved performance for accessing shared memory.

### BACKGROUND

A processor may be running separate workloads or worlds that may require substantial isolation between each other for security and/or reliability purposes. That is, a particular world should not have unintentional or purposeful access to code and/or data belonging to another world, unless the code and/or data is explicitly shared among the worlds. A processor may include a physical memory protection (PMP) to check memory access request from different worlds, and to approve or deny the requests to ensure that the worlds substantially operate independent of each other for security and/or reliability purposes.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to processor system. The processor system, includes: a first memory including a memory protection table including memory access permission information associated with a set of one or more worlds; and a processor including: an execution core configured to run a first world; and a table-based memory protection (TMP) configured to: receive a first request to access memory content at a first target address from the first world; access the memory access permission information from the memory protection table based on the first target address; and determine whether the first world is allowed to access the memory content at the first target address based on the accessed memory access permission information.

Another aspect of the disclosure relates to a method of providing memory protection. The method includes: receiving a first request to access memory content at a target address from a first world running on a processor execution core; accessing memory access permission information from a memory protection table stored in a first memory based on the target address; and determining whether the first world is allowed to access the memory content at the target address based on the accessed memory access permission information.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates a block diagram of an example processor system in accordance with an aspect of the disclosure.

FIG. 2 illustrates a block diagram of an example processor in accordance with another aspect of the disclosure.

FIG. 3 illustrates a block diagram of another example processor system in accordance with another aspect of the disclosure.

FIG. 4A illustrates a block diagram of another example processor system in accordance with another aspect of the disclosure.

FIG. 4B illustrates a flow diagram of an example method of accessing the same memory by two different worlds running on a processor in accordance with another aspect of the disclosure.

FIG. 5A illustrates a block diagram of another example processor system in accordance with another aspect of the disclosure.

FIG. 5B illustrates a diagram of an example memory protection table in accordance with another aspect of the disclosure.

FIG. 5C illustrates a diagram of another example memory protection table in accordance with another aspect of the disclosure.

FIG. 5D illustrates a flow diagram of another example method of accessing the same memory by two different worlds running on a processor in accordance with another aspect of the disclosure.

FIG. 6 illustrates a block diagram of another example processor system in accordance with another aspect of the disclosure.

FIG. 7 illustrates a block diagram of another example processor system in accordance with another aspect of the disclosure.

FIG. 8 illustrates a flow diagram of an example method of providing memory protection in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

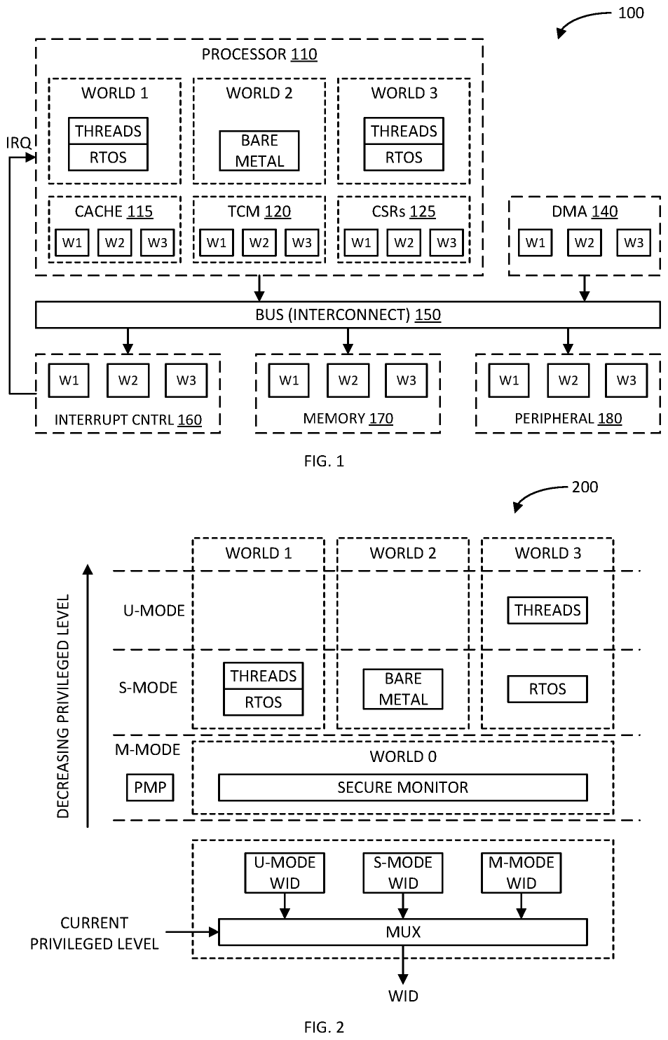

FIG. 1 illustrates a block diagram of an example processor system 100 in accordance with an aspect of the disclosure. The processor system 100 includes a processor 110, a direct memory access (DMA) 140, a bus (interconnect) 150, an interrupt controller 160, a memory 170, and a peripheral 180. The bus (interconnect) 150 is configured to data couple the processor 110, DMA 140, interrupt controller 160, memory 170, and peripheral 180 together. Additionally, the interrupt controller 160 may be coupled to the processor 110 (without traversing the bus 150) to provide thereto an interrupt request signal (IRQ).

The processor 110, which may be implemented as a reduced instruction set computer (RISC) version 5 (or RISC-V) hardware thread (HART) or other type, may include a cache 115, a tightly coupled memory (TCM) 120, and a set of control/status registers (CSRs) 125. In this example, the processor 110 is shown to be running three (3) workloads (separate programs), also known as Worlds 1, 2, and 3. Further, in accordance with this example, World 1 is running one or more threads under control of a real time operating system (RTOS); World 2 may be bare metal (e.g., running no application or operating system, but may have associated firmware); and World 3 may also be running one or more threads under the control of an RTOS.

For security reasons, the Worlds 1, 2, and 3 typically run substantially independently of each other, where code or software running in one world does not accidently or purposely affect code or software running in another world. Also, for reliability purposes, the worlds run substantially independent so that if one world crashes, the crash does not affect the other worlds. The independency of the Worlds 1, 2, and 3 also extend to other components of the processor 110 and the processor system 100. For example, contents or information in the cache 115, TCM 120, and CSRs 125 may pertain to World 1 (W1), World 2 (W2), and World 3 (W3). Similarly, contents, information, and code outside of the processor 110, such as in the interrupt controller 160, memory 170, and peripheral 180, may pertain to the different worlds W1, W2, and W3.

FIG. 2 illustrates a block diagram of an example processor 200 in accordance with another aspect of the disclosure. The processor 200 may be a more detailed implementation of the processor 110 of the processor system 100 previously discussed. The processor 200 is shown running the three (3) Worlds 1, 2, and 3. Similarly, World 1 is running one or more threads and a real time operating system (RTOS); World 2 is bare metal; and World 3 is also running one or more threads and an RTOS. Additionally, the processor 200 may be running a control World 0 to perform secure monitoring to ensure that the various Worlds 1, 2, and 3 are operated substantially independently, as discussed in more detail further herein.

From a privileged access perspective, the various Worlds 0, 1, 2, and 3 may include software components or code operating in various levels of access privileges. An arrow is shown in the diagram pointing in a direction of lower access privileged. In this example, the access privileged levels or modes, from highest to lowest, include a machine mode (M-mode), a supervisory mode (S-mode), and a user mode (U-mode).

In M-mode, the secure monitor of World 0 is able to access any memory/code that the various software components of the S-mode and U-mode of the Worlds 1-3 are able to access. In S-mode, the various components (e.g., threads/RTOS, bare metal, and RTOS of Worlds 1-3, respectively) may access any memory/code that the various software components of the U-mode of the Worlds 1-3 (e.g., thread of World 3), but not all the memory/code accessible by World 0 running in M-mode. Similarly, in U-mode, the various software components of the Worlds 1-3 (e.g., thread of World 3) may access its own privileged memory/code, but not all the memory/code accessible by software components running in M-and S-modes. Thus, the processor 200 implements access privileged from M-mode (e.g., where the software components are accessing machine-specific code in registers) to S-mode (e.g., where the software components are operating systems in nature), to U-mode (e.g., where the software components are user applications).

In this example, the processor 200 runs a particular world at a time, and switches between worlds under the control of the secure monitor of World 0. In M-mode, the processor 200 includes a physical memory protection (PMP), which includes a set of hardware logic comparators that may be programmed with address ranges for allowed memory access permissions for the currently-running or active world. Thus, prior to activating a particular world, the secure monitor of World 0 programs the PMP for the address ranges for allowed memory access permissions for the active world. For instance, if the secure monitor is to make World 1 active, the secure monitor programs the PMP with the address ranges for allowed memory access permissions for World 1, then makes World 1 the active running world on the processor 200. When the active World 1 requests retrieval of memory content, the request first goes to the PMP. If the PMP determines whether the memory address of the requested content is within the allowed range, and if it is, the memory access request is allowed. If the PMP determines that the memory address of the requested content is not within the allowed range, the memory access request may be denied. When the secure monitor is to switch to another world (e.g., World 3), the secure monitor preprograms the PMP with the address ranges for allowed memory access permissions for World 3, and then makes World 3 the active world of the processor 200.

As previously discussed, there are processing entities (e.g., DMA 140, interrupt controller 160, memory 170, and peripheral 180) outside of the processor 200 that operate in accordance with the active world. To inform such processing entities of the active world, the processor 200 further includes a multiplexer (MUX) that is configured to output the identifier of the active world (WID) based on the current privileged mode (e.g., U-mode, S-mode, and M-mode). Thus, the multiplexer informs the processing entities outside of the processor 200 of the active world and the corresponding privileged level for access (e.g., U-mode WID, S-mode WID, or M-mode WID).

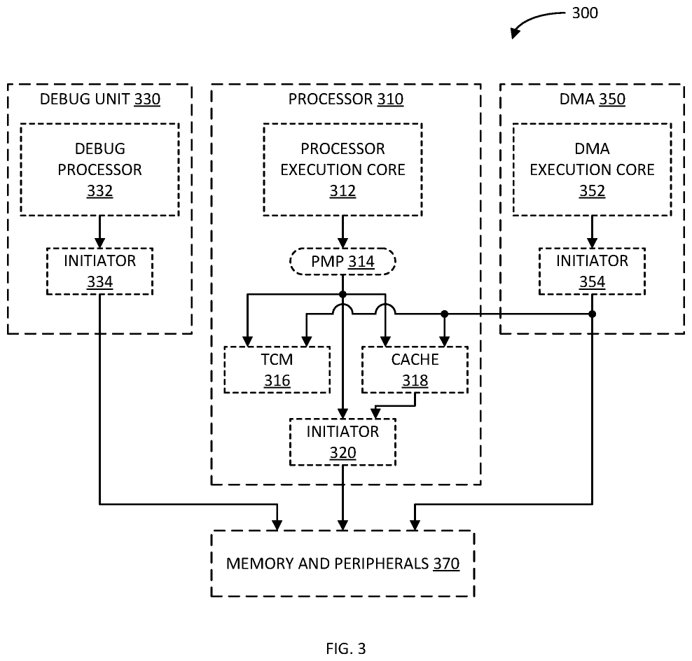

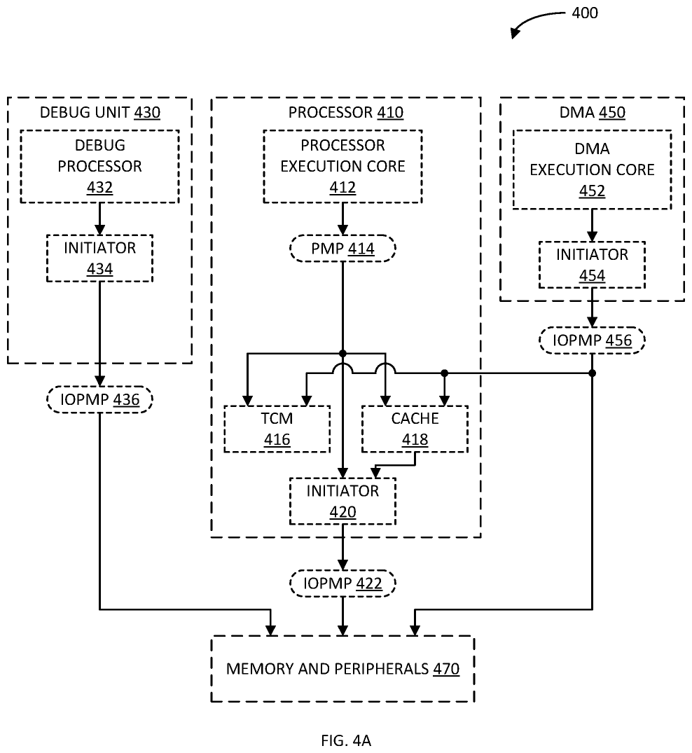

FIG. 3 illustrates a block diagram of another example processor system 300 in accordance with another aspect of the disclosure. The processor system 100 may be an example more detailed implementation of processor system 100. The processor system 300 includes a processor 310, a debug unit 330, a direct memory access (DMA) 350, and memory/peripherals 370.

The processor 310, in turn, includes a processor execution core 312, a physical memory protection (PMP) 314, a tightly coupled memory (TCM) 316, a cache 318, and an initiator 320. The processor execution core 312 may be configured to run a set of different worlds, such as World 1-3 previously discussed with regard to processor 200. The PMP 314 may be programmed with address ranges for allowed memory access permissions for the current active world running on the processor execution core 312. The active world running on the processor execution core 312 may access at least a portion of the TCM 316 if allowed by the PMP 314. Similarly, the active world running on the processor execution core 312 may access the cache 318 if allowed by the PMP 314. The active world running on the processor execution core 312 may access at least a portion of the memory/peripherals 370 via the initiator 320 if allowed by the PMP 314. Accordingly, the PMP 314 polices the memory access on behalf of the processor 310.

The debug unit 330 includes a debug processor 332 and an initiator 334. The debug processor 332 may need to access the memory/peripherals 370 via the initiator 334 for performing a number of debug operations. The DMA 350 includes a DMA execution core 352 and an initiator 354. The DMA execution core 352 may access the TCM 316 and the cache 318 of the processor 310, and also the memory/peripherals 370 via the initiator 354 for performing DMA operations. However, as discussed above, the PMP 314 provides memory protection on behalf of the processor 310, but not the debug unit 330 and the DMA 350. Thus, there may be a memory access security (or lack of security) issue with regard to the debug unit 330 and the DMA 350.

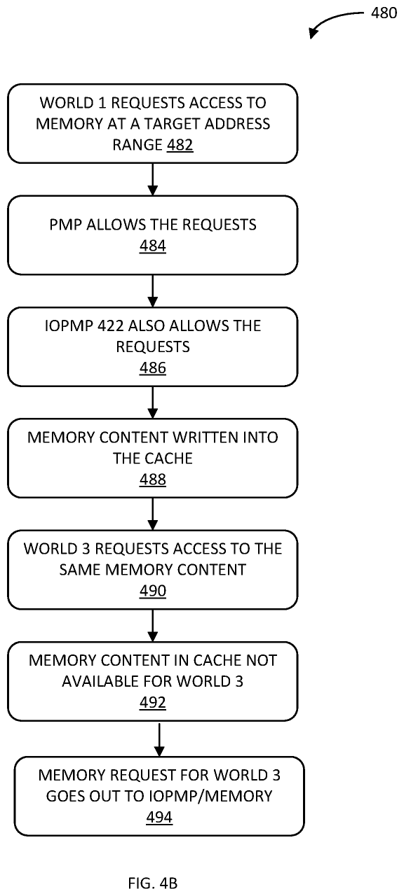

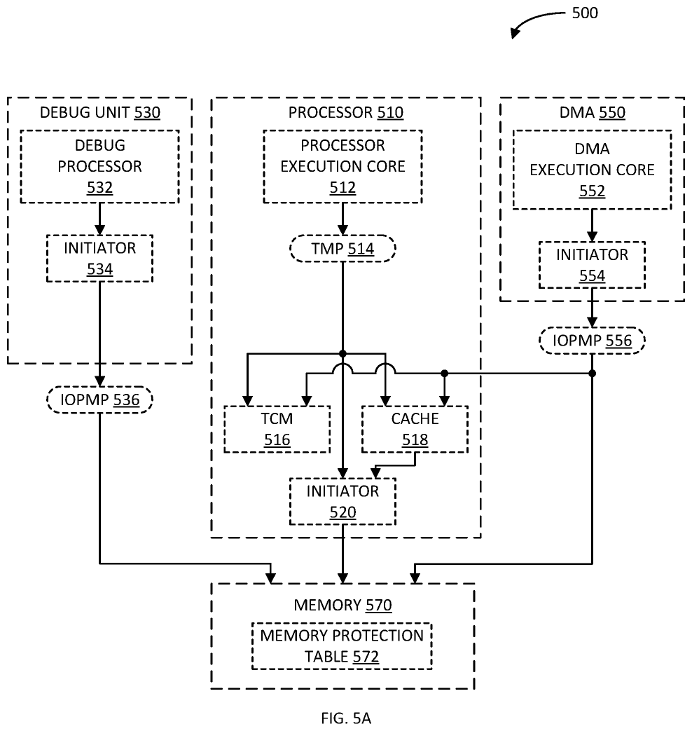

FIG. 4A illustrates a block diagram of another example processor system 400 in accordance with another aspect of the disclosure. The processor system 400 is similar to processor system 300 previously discussed, but includes various input/output physical memory protection (IOPMP) for providing memory protection for processing entities outside of a processor, such as a debug unit and a DMA, including additional memory protection for the processor, as discussed further herein. The processor system 400 includes a processor 410, a first IOPMP 422, a debug unit 430, a second IOPMP 436, a direct memory access (DMA) 450, a third IOPMP 456, and memory/peripherals 470.

The processor 410, in turn, includes a processor execution core 412, a physical memory protection (PMP) 414, a tightly coupled memory (TCM) 416, a cache 418, and an initiator 420. The processor execution core 412 may be configured to run a set of different worlds, such as World 1-3 previously discussed with reference to processor 200. The PMP 414 may be programmed with address ranges for allowed memory access permission for the current active world running on the processor execution core 412. The active world running on the processor execution core 412 may access at least a portion of the TCM 416 if allowed by the PMP 414. Similarly, the active world running on the processor execution core 412 may access the cache 418 if allowed by the PMP 414. In this case, the active world running on the processor execution core 412 may access at least a portion of the memory/peripherals 470 via the initiator 420 if allowed by both the PMP 414 and the IOPMP 422.

Thus, because of scalable-related limitations of the PMP 414, the PMP 414 may be programmed with a coarse allowable memory range, and the IOPMP 422 may be programmed with a finer allowable memory range for the processor 410 to access the memory 470. Within the coarse allowable memory range specified in the PMP 414, there may be some forbidden memory subranges that is specified in the IOPMP 422. Thus, even though the PMP 414 allows the memory access by the processor execution core 412 via the coarse allowable memory range, the IOPMP 422 may deny the memory access request via its finer memory range check.

The debug unit 430 includes a debug processor 432 and an initiator 434. The debug processor 432 may need to access at least a portion of the memory/peripherals 470 via the initiator 434 for performing a number of debug operations if allowed by the IOPMP 436. The DMA 450 includes a DMA execution core 452 and an initiator 454. The DMA execution core 452 may access at least a portion of the TCM 416 and the cache 418 of the processor 410 via the initiator 454 for DMA operations if allowed by the IOPMP 456. Additionally, the DMA execution core 452 may access at least a portion of the memory/peripherals 470 via the initiator 454 for performing DMA operations if allowed by the IOPMP 456. Thus, compared to the processor system 300, the processor system 400 provides memory access protection for the debug unit 430 and the DMA 450.

FIG. 4B illustrates a flow diagram of an example method 480 of sharing or accessing the same memory by two different worlds (e.g., Worlds 1 and 3) running on the processor 410 in accordance with another aspect of the disclosure. According to the method 480, World 1, actively running on the processor execution core 412, issues a requests to access memory at a target address range (block 482). The method 480 further includes the PMP 414 allowing the memory access request as the target address range falls within the programmed coarse allowable memory range (block 484). Additionally, the method 480 includes the IOPMP 422 also allowing the memory access requests as the target address range also falls within the programmed finer allowable memory range (block 486).

As the memory access request is allowed, the memory content associated with the memory access request at the target address range is written into the cache 418 (block 488). The secure monitor of the processor 410 reprograms the PMP 414 for World 3, makes World 3 the active world running on the processor execution core 412, and then World 3 issues a request to access the same memory previously accessed by World 1 (block 490). As previously discussed, the content of such memory access request now resides in the cache 418; and from a performance perspective, it would be advantageous for World 3 to access the memory content from cache 418 rather than from the memory 470. However, although the PMP 414 reprogrammed for World 3 allows the memory access request, accessing the memory content from the cache 418 by World 3 has not been allowed by the IOPMP 422. Thus, according to the method 480, the memory content in the cache 418 is not available for World 3 (block 492). Accordingly, the memory access request goes out to the IOPMP 422, and if approved, the memory content is recopied into cache 418, which impacts memory access performance (block 494).

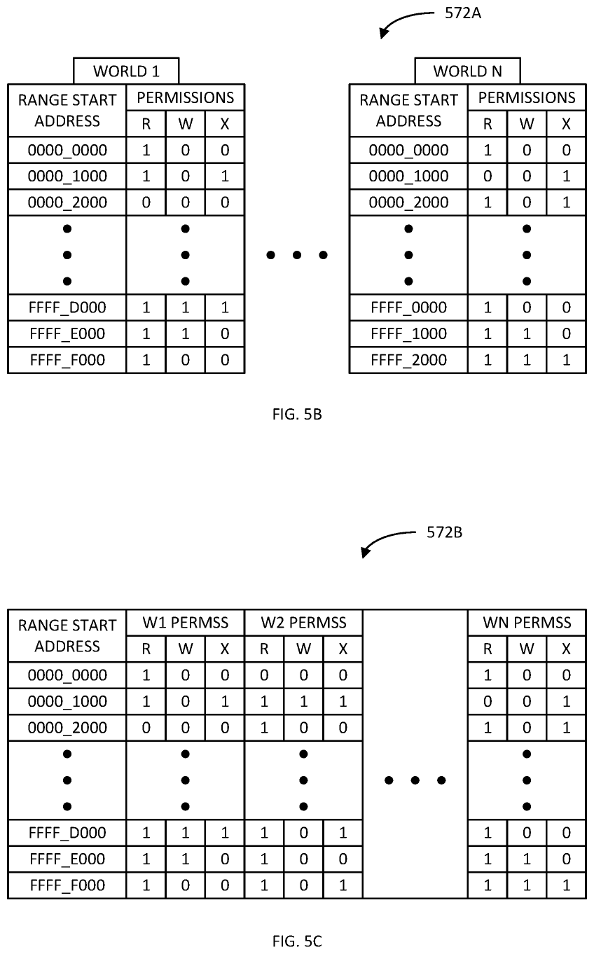

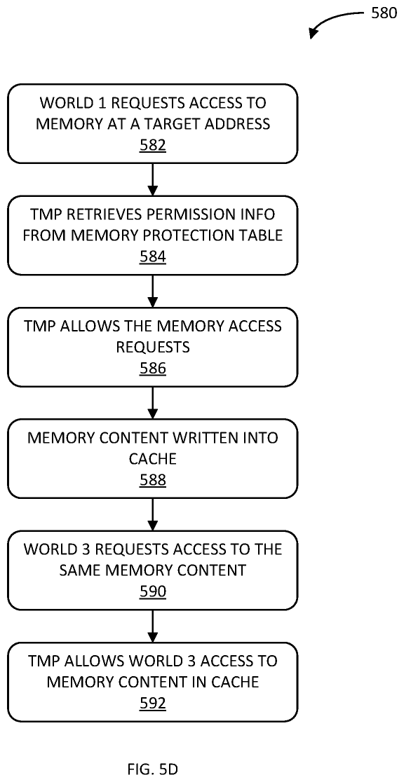

FIG. 5A illustrates a block diagram of another example processor system 500 in accordance with another aspect of the disclosure. As discussed further herein, the processor system 500 includes a table-based memory protection (TMP), which essentially accesses a portion of memory access permission information in a memory protection table stored in memory. The memory protection table includes memory access permission information associated with a set of memory ranges. The memory access permission information specifies who is able to access and the level of access of memory at corresponding memory ranges, respectively. When a portion of such memory protection table is accessed by the TMP of a processor, the TMP may have the privileged information as to the memory content in cache. Thus, even though a world switch has occurred, the TMP may have the information of whether the active world is able to access the memory content in cache.

In particular, the processor system 500 includes a processor 510, a debug unit 530, a first IOPMP 536, a direct memory access (DMA) 550, a second IOPMP 556, and a memory 570. The processor 510, in turn, includes a processor execution core 512, a table-based memory protection (TMP) 514, a tightly coupled memory (TCM) 516, a cache 518, and an initiator 520. The debug unit 530 includes a debug processor 532 and an initiator 534. The DMA 550 includes a DMA execution core 552 and an initiator 554. The memory 570 includes a memory protection table 572, which, as discussed above, includes memory access permission information associated a set of memory address ranges, respectively.

The processor execution core 512 may be configured to run a set of different worlds, such as World 1-3 previously discussed with processor 200. When an active world (e.g., World 1) issues a memory access request for memory content at a target address, the TMP 514 accesses the corresponding permission information associated with the target address from the memory protection table 572 in memory 570 (if it has not already done so). If the TMP 514 determines that the memory access request by World 1 is allowed based on the permission information, the memory access request is allowed to go to the memory 570, and the corresponding memory content is then written into the cache 518. If the active world running on the processor execution core 512 is switched (e.g., to World 3), and World 3 now issues a memory access request for the same memory content previously accessed by World 1, and the TMP 514 allows the memory access requests based on the permission information it previously accessed, the TMP 514 allows World 3 to access the memory content from cache 518. This is a significant improvement over processor system 400 that required the active World 3 to access the same content in cache 418 from the memory 470.

The debug processor 532 may need to access at least a portion of the memory 570 via the initiator 534 for performing a number of debug operations if allowed by the IOPMP 536. The DMA execution core 552 may access at least a portion of the TCM 516 and the cache 518 of the processor 510 via the initiator 554 for DMA operations if allowed by the IOPMP 556. Similarly, the DMA execution core 552 may access at least a portion of the memory 570 via the initiator 554 for performing DMA operations if allowed by the IOPMP 556.

FIG. 5B illustrates a diagram of an example memory protection table 572A in accordance with another aspect of the disclosure. The memory protection table 572A may be an example implementation of the memory protection table 572 previously discussed. The memory protection table 572A includes a set of sub-tables for a set of worlds 1-N, respectively. Each sub-table provides memory access permission information for the corresponding world.

Each sub-table includes a first (left) column for a set of fixed size memory ranges (e.g., four (4) kilobytes (kB) in size or other size), with the entries in the column corresponding to the start addresses in hexadecimal (e.g., 0000_0000, 0000_1000, etc.) of the fixed size memory ranges, respectively. Each sub-table includes a second (right) column for a set of memory access permissions corresponding to the memory ranges in the same rows, respectively. Each permission entry includes a read (R), write (W), and execute (X). For example, if the read (R) value is a one (1), the memory access permission allows read access to the data in the corresponding memory range; otherwise, if it is zero (0), the read access is denied. Similarly, if the write (W) value is a one (1), the memory access permission allows writing data into memory at the corresponding memory range; otherwise, if it is zero (0), the write operation is denied. In the same token, if the executable (X) value is a one (1), the memory access permission allows code in the memory at the corresponding memory range to be accessed and executed; otherwise, if it is zero (0), the executable operation is denied.

Considering some examples, if the TMP 514 receives a memory access request to read content within the fixed address range starting with 0000_0000 from World 1 running on the processor execution core 512, the TMP 514 may copy the permissions information (R=1, W=0, and X=0) from the sub-table for World 1, and allow the read memory access request as R=1 for World 1. If, on the other hand, the memory access request is to execute code within the fixed address range starting with 0000_0000, the TMP 514 denies the request from World 1 as X=0.

Similarly, if the TMP 514 receives a memory access request to read content within the fixed address range starting with 0000_2000 from World 3 (where N=3) running on the processor execution core 512, the TMP 514 may copy the permissions information (R=1, W=0, and X=1) from the sub-table for World 3, and allow the read memory access request as R=1 for World 3. If, on the other hand, the memory access request is for writing data into memory within the fixed address range starting with 0000_2000, the TMP 514 denies the request from World 3 as W=0.

FIG. 5C illustrates a diagram of another example memory protection table 572B in accordance with another aspect of the disclosure. The memory protection table 572B may be another example implementation of the memory protection table 572 previously discussed. In memory protection table 572A, the TMP 514 had to specify the memory range and the identifier of the World to access the corresponding sub-table, and then access the memory access permission information based on the memory range. In memory protection table 572B, the TMP 514 only needs to specify the memory range of the memory access request, and receives the memory access permissions for all the worlds running on the processor execution core 512. It shall be understood that the memory protection table may be organized in many different manners apart from the two examples 572A and 572B described herein.

In particular, the memory protection table 572B includes a first (left) column for a set of fixed size memory ranges (e.g., four (4) kilobytes (kB) in size or other size), with the entries in the column corresponding to the start addresses in hexadecimal (e.g., 0000_0000, 0000_1000, etc.) of the fixed size memory ranges, respectively. The memory protection table 572B further includes a set of columns for a set of memory access permissions for a set of worlds W1 to WN corresponding to the memory ranges in the same rows, respectively. Each permission entry for the set of worlds W1 to WN includes a read (R), write (W), and execute (X), as previously discussed with respect to memory protection table 572A.

Considering some examples, if the TMP 514 receives a memory access request to read content within the fixed address range starting with 0000_0000 from World 1 running on the processor execution core 512, the TMP 514 may copy all of the permissions information for the set of worlds 1-N associated with memory range starting with 0000_0000. Thus, the TMP 514 approves the memory access request from World 1 as the read (R) value is a one (1), and may copy the corresponding memory content into cache 518. If the active world running on the processor execution core 512 is changed to World N, and the TMP 514 receives another memory access request to read content within the fixed address range starting with 0000_0000 from World N, the TMP 514, which may already have the permission information from the previous access in response to the memory access request from World 1, approves the memory access request from World N as the read (R) value is a one (1), and memory content in the cache 518 may be provided to World N without accessing the same content in the memory 570.

FIG. 5D illustrates a flow diagram of an example method 580 of sharing or accessing the same memory by two different worlds (e.g., Worlds 1 and 3) running on the processor 510 in accordance with another aspect of the disclosure. According to the method 580, World 1, actively running on the processor execution core 512, sends a requests to access memory at a target address to the TMP 514 (block 582). The method 580 further includes the TMP 514, in response to the memory access request, retrieving the permission information associated with the target address from the memory protection table 572 stored in the memory 570 (block 584). The operation of block 584 is assuming the TMP 514 has not previously accessed the permission information in response to a prior memory access request.

The method 580 further includes the TMP 514 allowing the memory access request based on the retrieved permission information (block 586). The memory access request is allowed to pass to the memory 570 (e.g., via the cache 518 if it is a miss), where the corresponding memory content is written into the cache 518 (block 588). The active world running on the processor execution core 512 is now switched to World 3, and World 3 sends a memory access request to the TMP 514 for the same memory content previously accessed by World 1 (block 590). Then, according to the method 580, the TMP 514 (which may locally have the permission information or may access it from the memory protection table 572) allows the access to the memory content stored in the cache 518 by World 3 (block 592).

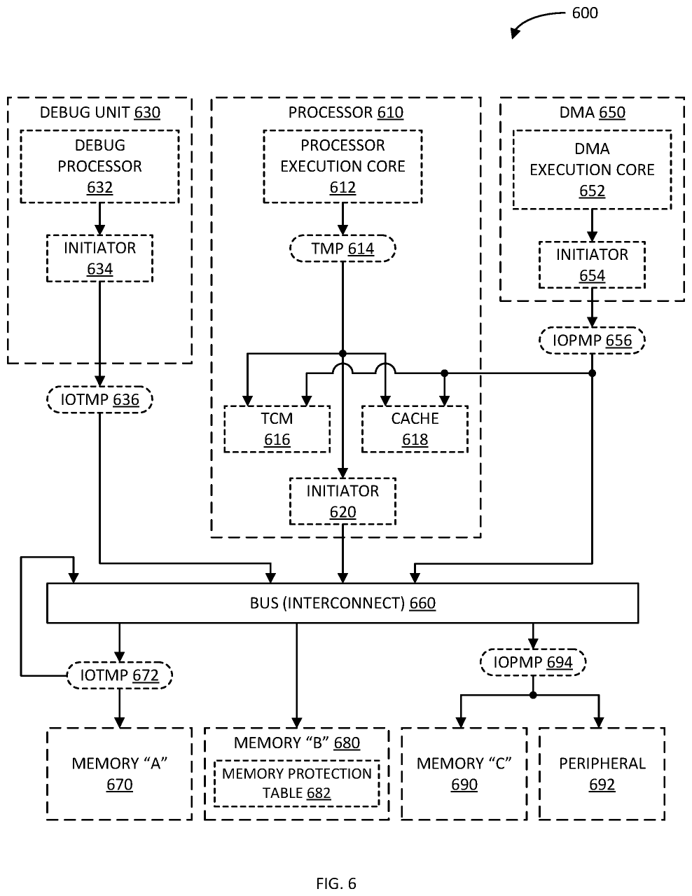

FIG. 6 illustrates a block diagram of another example processor system 600 in accordance with another aspect of the disclosure. In processor system 500 previously discussed, the processor 510 was implemented with a table-based memory protection (TMP) 514, which accessed a memory protection table 572 stored in memory 570 for performing memory access permission checks for different worlds running on the processor 510. As previously discussed, the memory protection table 572, which may be implemented per memory protection table 572A, 572B, or other, includes the memory access permission information for the various worlds running on the processor 510. A portion of such memory protection table 572 associated with a memory access request is accessed by the TMP 514, which informs the TMP 514 as to which world is allowed to access to the memory content associated with the memory access request. In processor system 600, the TMP feature is extended outside of the processor to various other processing entities.

In particular, the processor system 600 includes a processor 610, a debug unit 630, a first input/output table-based memory protection (IOTMP) 636, a direct memory access (DMA) 650, a first input/output physical memory protection (IOPMP) 656, a bus (interconnect) 660, a second IOTMP 672, a first memory “A” 670, a second memory “B” 680, a second IOPMP 694, a third memory “C” 690, and a peripheral 690.

The processor 610, in turn, includes a processor execution core 612, a table-based memory protection (TMP) 614, a tightly coupled memory (TCM) 616, a cache 618, and an initiator 620. The debug unit 630 includes a debug processor 632 and an initiator 634. The DMA 650 includes a DMA execution core 652 and an initiator 654. The initiator 620 of the processor 610 is coupled to the bus 660. The first IOTMP 636 is coupled between the initiator 634 of the debug unit 630 and the bus 660. The first IOPMP 656 is coupled between the initiator 654 of the DMA 650 and the TCM 616 and cache 618 of the processor 610, as well as the bus 660.

The second IOTMP 672 is coupled between the bus 660 and the first memory “A” 670, and includes a feedback connection to the bus 660 for accessing a memory protection table 682 stored in the second memory “B” 680. As discussed, the second memory “B” 680 is coupled to the bus 660, and includes the memory protection table 682. As previously discussed, the memory protection table 682, which may be implemented per memory protection table 572A, 572B, or other, includes the memory access permission information for the various worlds running on the processor 610 and the other processing entities 630 and 650. The second IOPMP 694 is coupled between the bus 660 and the third memory “C” 690 and the peripheral 692, respectively.

The TMP 614 of the processor 610 operates in a similar manner as TMP 514 of processor 510 previously discussed in detail. That is, when an active world (e.g., World 1) sends a memory access request for memory content at a target range to the TMP 614, the TMP 614 accesses the corresponding permission information from the memory protection table 682 in the second memory “B” 680 via the bus 660 (if it has not already done so). If the TMP 614 determines that the memory access request by World 1 is allowed based on the permission information, the memory access request is allowed to pass to the second memory “B” 680 via the bus 660 (e.g., via the cache 618 is it is a miss), and the corresponding memory content is then written into the cache 618. If the active world running on the processor execution core 612 is switched (e.g., to World 3), and World 3 now sends a memory access request to the TMP 614 for the same memory content previously accessed by World 1, the TMP 614 may allow the memory access requests based on the permission information it previously accessed, and World 3 is able to access the memory content from cache 618.

In processor system 600, the TMP is extended to processing entities, such as the debug unit 630 and the first memory “A” 670 in the form of first and second IOTMPs 636 and 672. For instance, if the debug processor 632 needs to access the first memory “A” 670 or second “B” memory 680 via the initiator 634, the IOTMP 636 accesses the corresponding permission information associated with the memory access request from the memory protection table 682 in the second memory “B” 680 via the bus 660 (if it has not already done so). If the IOTMP 636 determines that the memory access is allowed based on the permission information, the memory access request is allowed to go the first memory “A” 670 or second “B” memory 680 via the bus 660, and the corresponding memory content is provided to the debug processor 632 via the bus 660.

The TMP/IOTMP and PMP/IOPMP in a processor system may coexist. In this regard, if the DMA execution core 652 needs to access the first memory “A” 670 via the initiator 634 and it is allowed by the IOPMP 656, the IOTMP 672 receives the memory access request from the DMA 650 via the bus 660, then accesses the corresponding permission information associated with the memory access request from the memory protection table 682 in the second memory “B” 680 via a request sent by way of the feedback connection to bus 660. If the IOTMP 672 determines that the memory access is allowed based on the permission information, the corresponding memory content in the first memory “A” 670 is provided to the DMA execution core 652 via the bus 660.

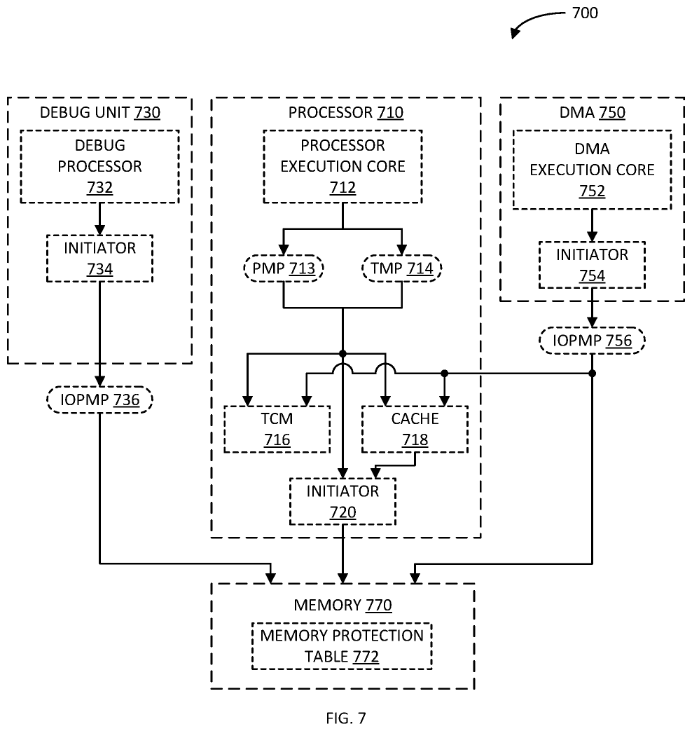

FIG. 7 illustrates a block diagram of another example processor system 700 in accordance with another aspect of the disclosure. As previously mentioned, a physical memory protection (PMP) and a table-based memory protection (TMP) may coexist. Accordingly, the processor system 700 is similar to processor system 500 previously discussed in detail, including the same entities identified by the same reference numbers with the exception that the most significant digit is a “7” in processor system 700 instead of a “5” as in processor system 500.

In processor system 700, the processor 710 further includes a PMP 713 coupled in parallel with the TMP 714, i.e., both coexists in the processor 710. As an example, the PMP 713 may be implemented to perform memory access permission checks for a certain memory address sub-range (e.g., an address sub-range that points to the TCM 716), and the TMP 714 may be implemented to perform memory access permission checks for another memory address sub-range (e.g., an address sub-range that points to the memory 770). Thus, based on the address of the memory access request, the PMP 713 or the TMP 714 will handle the permission check.

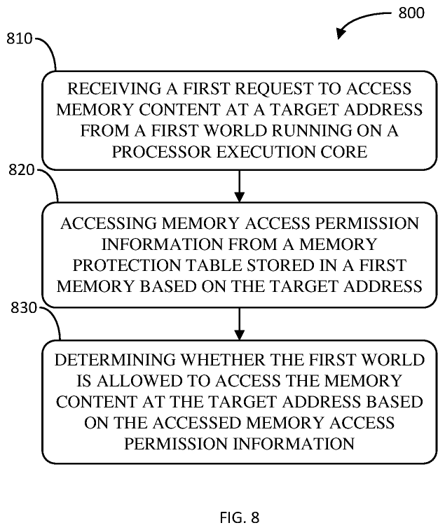

FIG. 8 illustrates a flow diagram of an example method 800 of providing memory protection in accordance with another aspect of the disclosure. The method 800 includes receiving a first request to access memory content at a target address from a first world running on a processor execution core (block 810). The method 800 further includes accessing memory access permission information from a memory protection table stored in a first memory based on the target address (block 820). Additionally, the method 800 includes determining whether the first world is allowed to access the memory content at the target address based on the accessed memory access permission information (block 830).

Some of the components described herein, such as one or more of the subsystems, thermal controllers, and communication interfaces, may be implemented using a processor. A processor, as used herein, may be any dedicated circuit, processor-based hardware, a processing core of a system on chip (SOC), etc. Hardware examples of a processor may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor may be coupled to memory (e.g., generally a computer-readable media or medium), such as a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

The following provides an overview of aspects of the present disclosure:
Aspect 1: A processor system, comprising: a first memory comprising a memory protection table including memory access permission information associated with a set of one or more worlds; and a processor comprising: an execution core configured to run a first world; and a table-based memory protection (TMP) configured to: receive a first request to access memory content at a first target address from the first world; access the memory access permission information from the memory protection table based on the first target address; and determine whether the first world is allowed to access the memory content at the first target address based on the accessed memory access permission information.
Aspect 2: The processor system of aspect 1, wherein the TMP is configured to pass the first memory access request to the first memory or a second memory in response to the TMP determining that the first world is allowed to access the memory content at the first target address.
Aspect 3: The processor system of aspect 2, wherein the processor system comprises a cache, and wherein the memory content at the first target address is copied into the cache.
Aspect 4: The processor system of aspect 3, wherein: the execution core is further configured to run a second world; and the TMP is configured to: receive a second request to access the memory content at the first target address from the second world; and determine whether the second world is allowed to access the memory content at the first target address based on the accessed memory access permission information.
Aspect 5: The processor system of aspect 4, wherein the TMP is configured to pass the second memory access request to the cache for accessing the memory content by the second world in response to determining that the second world is allowed to access the memory content at the first target address.
Aspect 6: The processor system of aspect 4, wherein the TMP is configured to deny the second memory access request in response to determining that the second world is not allowed to access the memory content at the first target address.
Aspect 7: The processor system of aspect 4, wherein the TMP is further configured to: access memory access permission information from the memory protection table based on the second request; and determine whether the second world is allowed to access the memory content at the first target address based on the accessed memory access permission information associated with the second request.
Aspect 8: The processor system of aspect 7, wherein the TMP is configured to pass the second memory access request to the cache for accessing the memory content by the second world in response to determining that the second world is allowed to access the memory content at the first target address.
Aspect 9: The processor system of aspect 7, wherein the TMP is configured to deny the second memory access request in response to determining that the second world is not allowed to access the memory content at the first target address.
Aspect 10: The processor system of aspect 2, wherein the TMP is configured to deny the first memory access request in response to determining that the first world is not allowed to access the memory content at the first target address.
Aspect 11: The processor system of any one of aspects 2-10, wherein the processor further comprises a tightly coupled memory (TCM), and wherein the second memory comprises the TCM.
Aspect 12: The processor system of any one of aspects 1-11, wherein the processor further comprises a physical memory protection (PMP) configured to: be programmed to include memory access permission information for the first world with respect to a first memory address range; receive a second request to access memory content at a second target address within the first memory address range from the first world; and determine whether the first world is allowed to access the memory content at the second target address based on the programmed memory access permission information.
Aspect 13: The processor system of any one of aspects 1-12, further comprising: a processing entity; and an input/output table-based memory protection (IOTMP) configured to: receive a second request to access memory content at a second target address from the processing entity; access memory access permission information from the memory protection table based on the second target address; and determine whether the processing entity is allowed to access the memory content at the second target address based on the accessed memory access permission information associated with the second target address.
Aspect 14: The processor system of aspect 13, wherein the processing entity comprises a debug unit.
Aspect 15: The processor system of aspect 13, wherein the processing entity comprises a direct memory access (DMA).
Aspect 16: The processor system of any one of aspects 13-15, wherein the IOTMP is configured to pass the second memory access request to the first memory or a second memory in response to the IOTMP determining that the processing entity is allowed to access the memory content at the second target address.
Aspect 17: The processor system of any one of aspects 13-15, wherein the IOTMP is configured to deny the second memory access request in response to determining that the processing entity is not allowed to access the memory content at the second target address.
Aspect 18: The processor system of any one of aspects 1-17, further comprising: a bus; a processing entity; a second memory; and an input/output table-based memory protection (IOTMP) configured to: receive a second request to access memory content in the second memory at a second target address from the processing entity via the bus; access memory access permission information from the memory protection table based on the second target address via the bus; and determine whether the processing entity is allowed to access the memory content at the second target address based on the accessed memory access permission information associated with the second target address.
Aspect 19: A method of providing memory protection, comprising: receiving a first request to access memory content at a target address from a first world running on a processor execution core; accessing memory access permission information from a memory protection table stored in a first memory based on the target address; and determining whether the first world is allowed to access the memory content at the target address based on the accessed memory access permission information.
Aspect 20: The method of aspect 19, further comprising passing the first memory access request to the first memory or a second memory in response to determining that the first world is allowed to access the memory content at the target address.
Aspect 21: The method of aspect 20, further comprising writing the memory content at the target address to a cache.
Aspect 22: The method of aspect 21, further comprising: receiving a second request to access the memory content at the target address from a second world running on the processor execution core; and determining whether the second world is allowed to access the memory content at the target address based on the accessed memory access permission information.
Aspect 23: The method of aspect 22, further comprising passing the second memory access request to the cache for accessing the memory content by the second world in response to determining that the second world is allowed to access the memory content at the target address.
Aspect 24: The method of any one of aspects 21, further comprising: accessing memory access permission information from the memory protection table based on the second memory access request; and determining whether the second world is allowed to access the memory content at the first target address based on the accessed memory access permission information associated with the second memory access request.
Aspect 25: The method of any one of aspects 19-24, further comprising: programming a physical memory protection (PMP) to include memory access permission information for the first world with respect to a first memory address range; receiving, at the PMP, a second request to access memory content at a second target address within the first memory address range from the first world; and determining, at the PMP, whether the first world is allowed to access the memory content at the second target address based on the programmed memory access permission information.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. A processor system, comprising:
a first memory comprising a memory protection table including memory access permission information associated with a set of one or more worlds; and
a processor comprising:
an execution core configured to run a first world; and
a table-based memory protection (TMP) configured to:
receive a first request to access memory content at a first target address from the first world;
access the memory access permission information from the memory protection table based on the first target address; and
determine whether the first world is allowed to access the memory content at the first target address based on the accessed memory access permission information.

2. The processor system of claim 1, wherein the TMP is configured to pass the first memory access request to the first memory or a second memory in response to the TMP determining that the first world is allowed to access the memory content at the first target address.

3. The processor system of claim 2, wherein the processor system comprises a cache, and wherein the memory content at the first target address is copied into the cache.

4. The processor system of claim 3, wherein:
the execution core is further configured to run a second world; and
the TMP is configured to:
receive a second request to access the memory content at the first target address from the second world; and
determine whether the second world is allowed to access the memory content at the first target address based on the accessed memory access permission information.

5. The processor system of claim 4, wherein the TMP is configured to pass the second memory access request to the cache for accessing the memory content by the second world in response to determining that the second world is allowed to access the memory content at the first target address.

6. The processor system of claim 4, wherein the TMP is configured to deny the second memory access request in response to determining that the second world is not allowed to access the memory content at the first target address.

7. The processor system of claim 4, wherein the TMP is further configured to:
access memory access permission information from the memory protection table based on the second request; and
determine whether the second world is allowed to access the memory content at the first target address based on the accessed memory access permission information associated with the second request.

8. The processor system of claim 7, wherein the TMP is configured to pass the second memory access request to the cache for accessing the memory content by the second world in response to determining that the second world is allowed to access the memory content at the first target address.

9. The processor system of claim 7, wherein the TMP is configured to deny the second memory access request in response to determining that the second world is not allowed to access the memory content at the first target address.

10. The processor system of claim 2, wherein the TMP is configured to deny the first memory access request in response to determining that the first world is not allowed to access the memory content at the first target address.

11. The processor system of claim 2, wherein the processor further comprises a tightly coupled memory (TCM), and wherein the second memory comprises the TCM.

12. The processor system of claim 1, wherein the processor further comprises a physical memory protection (PMP) configured to:
be programmed to include memory access permission information for the first world with respect to a first memory address range;
receive a second request to access memory content at a second target address within the first memory address range from the first world; and
determine whether the first world is allowed to access the memory content at the second target address based on the programmed memory access permission information.

13. The processor system of claim 1, further comprising:
a processing entity; and
an input/output table-based memory protection (IOTMP) configured to:
receive a second request to access memory content at a second target address from the processing entity;
access memory access permission information from the memory protection table based on the second target address; and
determine whether the processing entity is allowed to access the memory content at the second target address based on the accessed memory access information associated with the second target address.

14. The processor system of claim 13, wherein the processing entity comprises a debug unit.

15. The processor system of claim 13, wherein the processing entity comprises a direct memory access (DMA).

16. The processor system of claim 13, wherein the IOTMP is configured to pass the second memory access request to the first memory or a second memory in response to the IOTMP determining that the processing entity is allowed to access the memory content at the second target address.

17. The processor system of claim 13, wherein the IOTMP is configured to deny the second memory access request in response to determining that the processing entity is not allowed to access the memory content at the second target address.

18. The processor system of claim 1, further comprising:
a bus;
a processing entity;
a second memory; and
an input/output table-based memory protection (IOTMP) configured to:
receive a second request to access memory content in the second memory at a second target address from the processing entity via the bus;
access memory access permission information from the memory protection table based on the second target address via the bus; and
determine whether the processing entity is allowed to access the memory content at the second target address based on the memory access permission information associated with the second target address.

19. A method of providing memory protection, comprising:
receiving a first request to access memory content at a target address from a first world running on a processor execution core;
accessing memory access permission information from a memory protection table stored in a first memory based on the target address; and
determining whether the first world is allowed to access the memory content at the target address based on the accessed memory access permission information.

20. The method of claim 19, further comprising passing the first memory access request to the first memory or a second memory in response to determining that the first world is allowed to access the memory content at the target address.

21. The method of claim 20, further comprising writing the memory content at the target address to a cache.

22. The method of claim 21, further comprising:
receiving a second request to access the memory content at the target address from a second world running on the processor execution core; and
determining whether the second world is allowed to access the memory content at the target address based on the accessed memory access permission information.

23. The method of claim 22, further comprising passing the second memory access request to the cache for accessing the memory content by the second world in response to determining that the second world is allowed to access the memory content at the target address.

24. The method of claim 21, further comprising:
accessing memory access permission information from the memory protection table based on the second memory access request; and
determining whether the second world is allowed to access the memory content at the first target address based on the accessed memory access permission information associated with the second memory access request.

25. The method of claim 19, further comprising:
programming a physical memory protection (PMP) to include memory access permission information for the first world with respect to a first memory address range;
receiving, at the PMP, a second request to access memory content at a second target address within the first memory address range from the first world; and
determining, at the PMP, whether the first world is allowed to access the memory content at the second target address based on the programmed memory access permission information.
